(19) United States
(12) Patent Application Publication
(10) Pub. No.: US 2013/0020801 A1
(43) Pub. Date: Jan. 24, 2013

(54) Sleeve For Tendon Bottom Connector

(71) Applicant: Guang Li, Houston, TX (US)

(72) Inventor: Guang Li, Houston, TX (US)

(73) Assignee: SEAHORSE EQUIPMENT CORP, Houston, TX (US)

(21) Appl. No.: 13/184,670

(22) Filed: Jul. 18, 2011

(51) Int. Cl. F16L 21/00; B23P 17/04

(52) U.S. Cl. 285/417; 29/428

(57) ABSTRACT

A sleeve, suitable for temporary use on a tendon for a tension leg platform (TLP) equipped with a bottom tendon connector, covers selected portions of the tendon and bottom tendon connector so as to provide an outer surface having fewer and/or less pronounced discontinuities in the outer diameter of the assembly. This improves the handling characteristics of the assembly in pipe tensioning devices and the like. The sleeve may be in form of split halves which may be held together around the selected portion of the tendon by band straps. The sleeve may be removed subsea by cutting the band straps using an ROV. In certain embodiments, the sleeve comprises an open frame arrangement of contoured segments held in a spaced-apart configuration by bolt-together or hinged clamps. The sleeve may provide an annular space between the tendon and the sleeve which may be used to house a flotation device.

### CROSS-REFERENCE TO RELATED APPLICATIONS

None

### STATEMENT REGARDING FEDERALLY SPONSORED RESEARCH OR DEVELOPMENT

Not Applicable

### BACKGROUND OF THE INVENTION

1. Field of the Invention

This invention relates to offshore platforms. More particularly, it relates to the tendons used to anchor tension leg platforms (TLPs).

2 Description of the Related Art Including Information Disclosed Under 37 CFR 1.97 and 1.98

A tension leg platform (TLP) is a vertically moored floating structure typically used for the offshore production of oil and/or gas, and is particularly suited for water depths greater than about 1000 ft.

The platform is permanently moored by tethers or tendons grouped at each of the structure's corners. A group of tethers is called a tension leg. The tethers have relatively high axial stiffness (low elasticity) such that virtually all vertical motion of the platform is eliminated. This allows the platform to have the production wellheads on deck (connected directly to the subsea wells by rigid risers), instead of on the seafloor. This feature enables less expensive well completions and allows better control over the production from the oil or gas reservoir.

A variety of TLP designs are known in the art. The following patents describe various examples.

U.S. Pat. No. 7,462,000 discloses a tension leg platform that includes a deck supported on the upper ends of three or more columns interconnected at the lower ends thereof by horizontally disposed pontoons. The columns are battered inwardly and upwardly from the pontoons to the deck. Tendons connected at the columns anchor the platform to the seabed. The footprints of the base of the battered columns and the tendons are larger than the footprint of the deck supported on the upper ends of the columns.

U.S. Pat. No. 4,585,373 describes a tension leg platform with exterior buoyant columns located outside the normal tension leg platform structure. The exterior columns are designed to decrease the pitch period of the tension leg platform away from the point of concentration of the largest wave spectrum energy encountered at a particular marine location. This modification of the pitch period of the tension leg platform is said to reduce the cyclic fatigue stresses in the tension legs of the platform thereby increasing the useful life of the platform structure.

U.S. Pat. No. 5,558,467 describes a deep water offshore apparatus for use in oil drilling and production in which an upper buoyant hull of prismatic shape has a passage that extends longitudinally through the hull. Risers run through the passage and down to the sea floor. A frame structure connected to the hull bottom and extending downwardly comprises a plurality of vertically arranged bays defined by vertically spaced horizontal water entrapment plates providing open windows around the periphery of the frame structure. The windows provide transparency to ocean currents and to wave motion in a horizontal direction to reduce drag. The frame structure serves to modify the natural period and stability of the apparatus to minimize heave, pitch, and roll motions of the apparatus. A keel assembly at the bottom of the frame structure has ballast chambers for enabling the apparatus to float horizontally and for stabilization of the apparatus against tilting in the vertical position.

U.S. Pat. No. 4,169,424 describes a tension leg buoyancy structure for use in seas exposed to wave action that includes a buoyancy section, an anchor section which rests on the sea bed, and a plurality of parallel tethers connecting the buoyancy section with the anchor section to permit the buoyancy section to move relative to the anchor section. Design parameters are selected such that the natural period of the buoyancy section for linear oscillation in the direction of wave travel, the natural period of the buoyancy section for linear oscillation in a horizontal direction perpendicular to the direction of wave travel, and the natural period of the buoyancy section for rotational oscillation about a vertical axis of the buoyancy section structure are greater than 50 seconds.

U.S. Pat. No. 4,829,928 describes an ocean platform that has a negatively buoyant pontoon suspended from the balance of the platform to increase the heave resonant period. Tendons suspend the pontoon to a depth where dynamic wave forces do not materially act directly on it in seas of normally occurring periods of up to about 15 seconds but do in seas of periods above about 15 seconds. Columns and an upper pontoon provide buoyancy for the platform.

U.S. Pat. No. 5,707,178 describes a tension base for a tension leg platform. A buoyant base is submerged below the water surface and is retained with base tendons to a foundation on the sea floor. The buoyant base is attachable to the mooring tendons of a tension leg vessel positioned above the buoyant base. The buoyant base can be selectively ballasted to control the tension in the base tendons. Additional buoyant bases and connecting tendons can extend the depth of the total structure. Mooring lines can be connected between the buoyant base and the sea floor to limit lateral movement of the buoyant base. The buoyant base creates a submerged foundation which is said to reduce the required length of a conventional tension leg platform. The tension leg platform can be detached from the buoyant base and moved to another location.

U.S. Pat. No. 4,585,373 describes a pitch period reduction apparatus for tension leg platforms. A tension leg platform is provided with exterior buoyant columns located outside the normal tension leg platform structure. The exterior columns decrease the pitch period of the tension leg platform away from the point of concentration of the largest wave spectrum energy encountered at a particular marine location. Modification of the pitch period of the tension leg platform in this manner is said to reduce the cyclic fatigue stresses in the tension legs of the platform, and thereby increase the useful life of the platform structure.

U.S. Pat. No. 7,854,570 discloses a pontoonless tension leg platform (TLP) that has a plurality of buoyant columns connected by an above-water deck support structure. The design eliminates the need for subsea pontoons extending between the surface-piercing columns. In certain embodiments, the buoyancy of the columns is increased by the addition of subsea sections of increased diameter (and/or cross-sectional area) to provide the buoyancy furnished by the pontoons of the TLPs of the prior art. A pontoonless TLP has a smaller subsea projected area in both the horizontal and vertical planes than a conventional multi-column TLP of equivalent load-bearing capacity having pontoons between the columns. This reduction in surface area produces a corresponding reduction in the platform's response to ocean currents and wave action and consequently allows the use of smaller and/or less costly mooring systems. Moreover, the smaller vertical projected area results in a shorter natural period which enables a pontoonless TLP according to the invention to be used in water depths where conventional TLPs cannot be used due to their longer natural periods. The absence of pontoons in a multi-column TLP also has the added benefit of providing an unobstructed path for risers to connect with the deck of the platform.

U.S. Pat. No. 6,447,208 describes an extended-base tension leg substructure for supporting an offshore platform where the substructure includes a plurality of support columns disposed about a central axis of the substructure and interconnected by at least one pontoon. Each column comprises an above water and submerged portion. The substructure also includes a plurality of wings or arms radiating from the columns and/or the pontoons, each wing securing at least one tendon extending from a wing to an anchor on the seabed. It is said that the wings minimize translational movement and rotational flex in the substructure reducing fatigue in the tendons and their connections.

U.S. Pat. No. 7,621,698 describes a rotating lock ring bottom tendon connector. The tendon bottom connector assembly has a receptacle with a bore having an annular locking profile divided into segments by axially extending slots. The connector has a housing that inserts into and locks in the receptacle. The housing and receptacle have mating anti-rotation elements. The lock ring has an outer surface with an annular locking profile divided into segments by axially extending slots. The lock ring is carried by the housing initially in the installation position with its segments aligned with the slots of the receptacle. This position allows the housing to be fully inserted into the receptacle. An ROV then rotates the ring from the installation position to a locked position, with the segments of the lock ring engaging the segments of the receptacle. Alternatively, a split ring with one end fixed rotates the lock ring.

In the past, the tendons of a TLP were either assembled vertically at an offshore location by joining segments together as the tendon was lowered towards the seafloor or assembled horizontally onshore and subsequently towed to the TLP's installation site where they were up-ended and connected to piles driven into the seafloor. Both of these prior art methods are difficult to perform and may expose the tendon assembly to potentially damaging conditions—e.g., bending loads and uncontrolled sinking.

U.S. patent application Ser. No. 13/095,597 filed Apr. 27, 2011, and entitled “Method for assembling tendons” (the disclosure of which is hereby incorporated by reference in its entirety) describes a novel method wherein a tendon is assembled in a horizontal orientation at or near the installation site of a TLP using connectors or weld stations on a barge or other vessel. During assembly, the tendon is pulled away from the assembly vessel and tensioned by a tug or offshore work vessel. When fully assembled, the tendon is up-ended (in a manner similar to a wet-towed tendon) and then either preinstalled using floats or passed over to the TLP which is on-site and ready to receive tendons.

### SUMMARY OF THE INVENTION

An apparatus according to the invention comprises a sleeve that is configured for temporary use on a tension leg platform (TLP) tendon equipped with a bottom tendon connector. The sleeve is designed to cover selected portions of the tendon and its bottom tendon connector so as to provide an outer surface having fewer and/or less pronounced discontinuities in the outer diameter of the assembly. This improves the handling characteristics of the tendon assembly in pipe tensioning devices and the like. The sleeve may be in form of split halves which may be held together around the selected portion of the tendon by band straps. The sleeve may be removed subsea by cutting the band straps using an ROV. In certain embodiments, the sleeve comprises an open frame arrangement of contoured segments that are held in a spaced-apart configuration by bolt-together or hinged clamps. The sleeve may provide an annular space between the tendon and the sleeve which may be used to house a supplementary flotation device.

A tendon assembly method according to the invention may comprise attaching a sleeve around a portion of the tendon bottom connector and assembling a tendon by joining tendon segments together in a horizontal orientation on a first floating vessel to produce a tendon assembly while simultaneously applying a tension load via the tendon sleeve to the tendon assembly with a second vessel that is remote from the first vessel. Alternatively, the sleeve may be installed on an opposing, second end of the tendon assembly and used to apply a tension load to the tendon assembly while it is floating in the sea so as to maintain it in substantially linear alignment.

BRIEF DESCRIPTION OF THE SEVERAL VIEWS OF THE DRAWING(S)

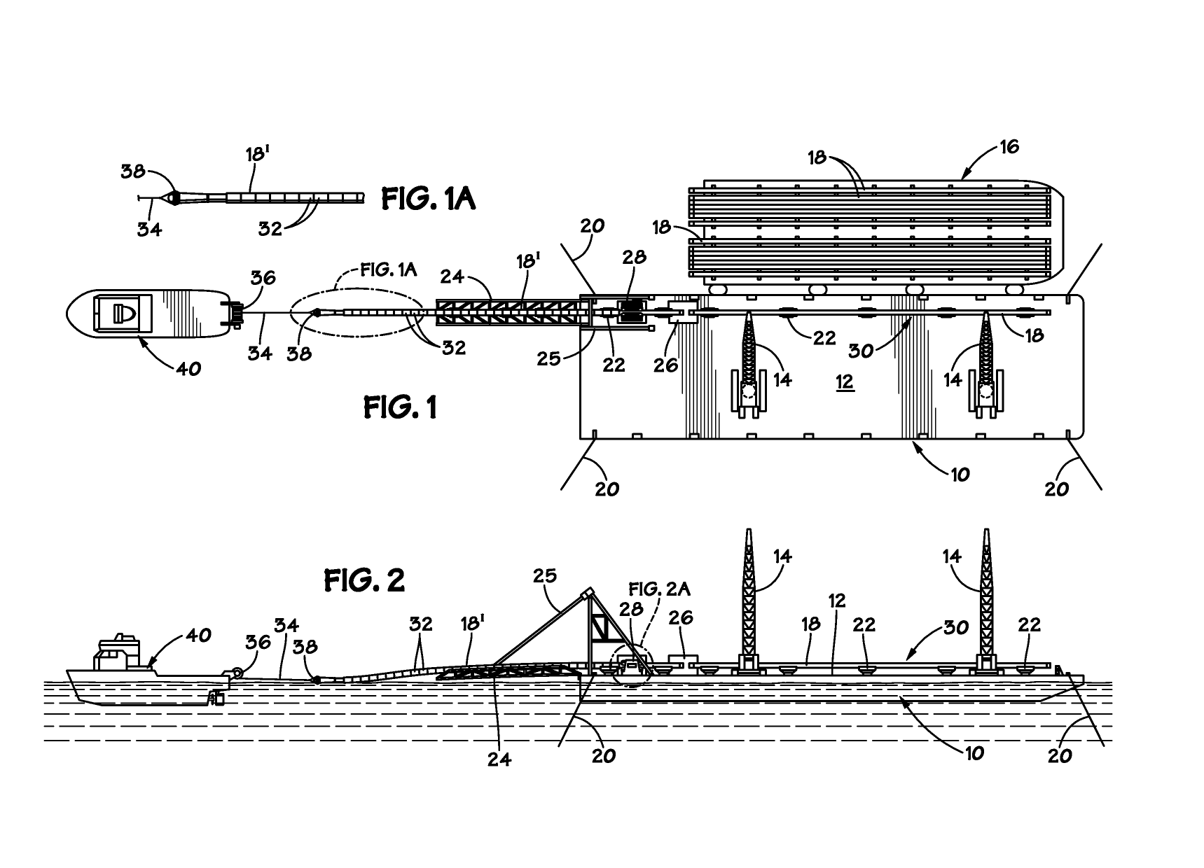

FIG. 1 is a top plan view of a tendon being assembled on a tendon assembly vessel while the tendon is tensioned by a tug.

FIG. 1A is an enlargement of the portion indicated in FIG. 1.

FIG. 2 is a side view of the tendon assembly apparatus illustrated in FIG. 1.

FIG. 2A is a side view of a prior art pipe tensioning device.

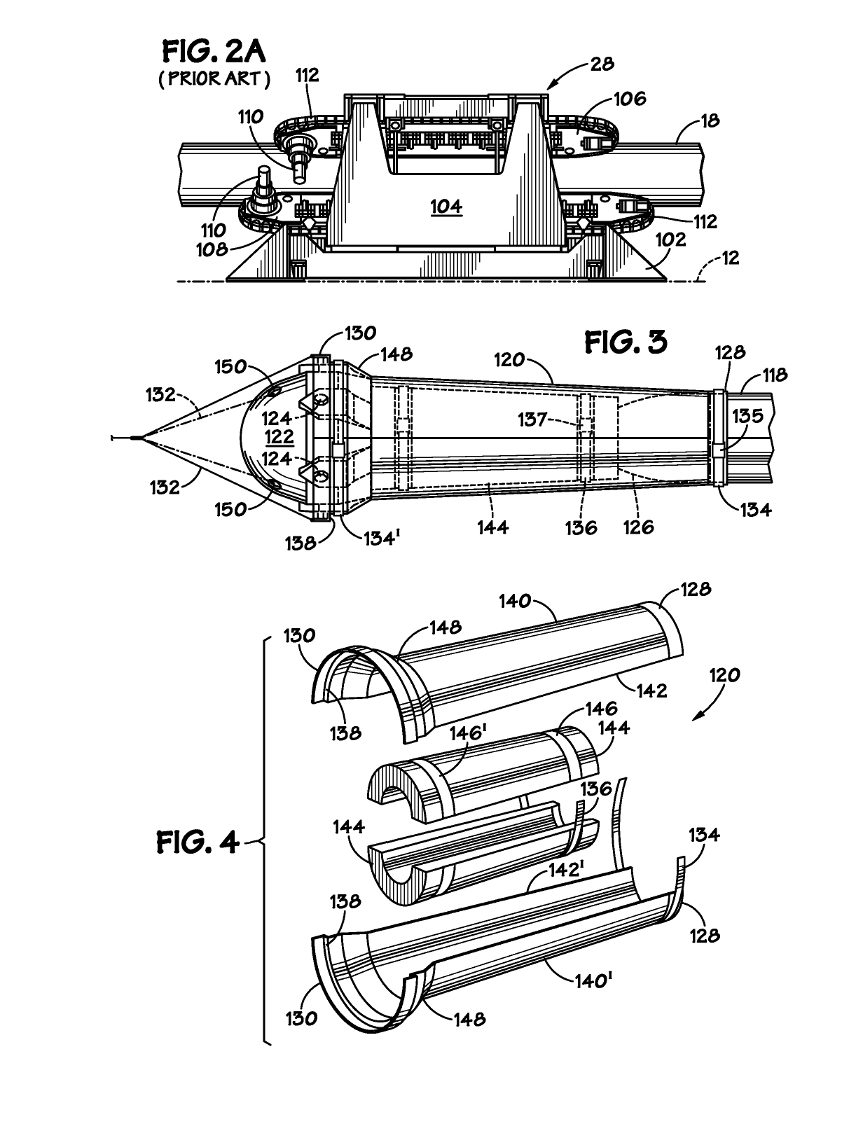

FIG. 3 is a side view of a tendon sleeve according to a first embodiment of the invention installed on the bottom portion of a tendon, the covered portions of which are shown in phantom. Also shown in phantom are associated flotation devices within the sleeve

FIG. 4 is an exploded view of a tendon sleeve and its associated floatation device according to a first embodiment of the invention.

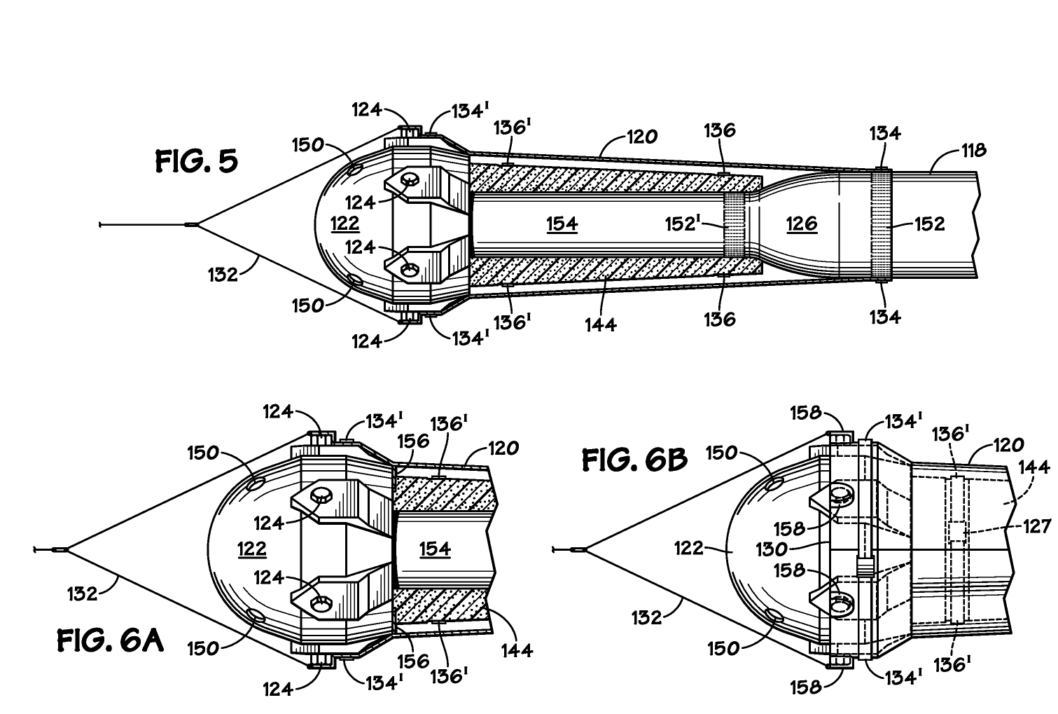

FIG. 5 is a cross-sectional view of the tendon sleeve illustrated in FIG. 3.

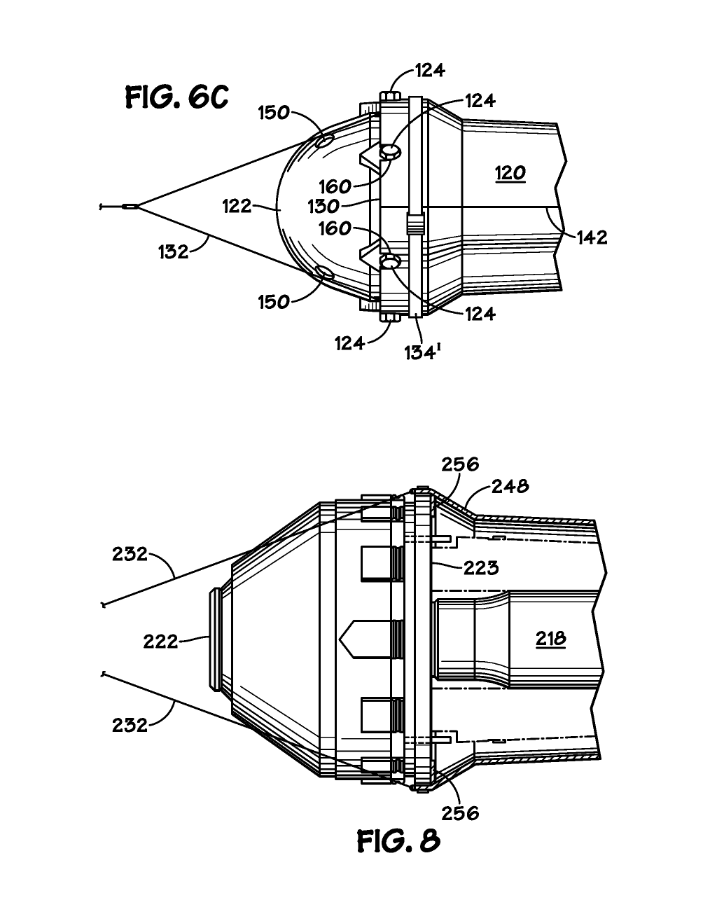

FIG. 6A is a partial cross-sectional view of a tendon sleeve according to a second embodiment of the invention shown installed on a tendon bottom connector.

FIG. 6B is a partial cross-sectional view of a tendon sleeve according to a third embodiment of the invention shown installed on a tendon bottom connector.

FIG. 6C is a partial side view of a tendon sleeve according to a fourth embodiment of the invention shown installed on a tendon bottom connector.

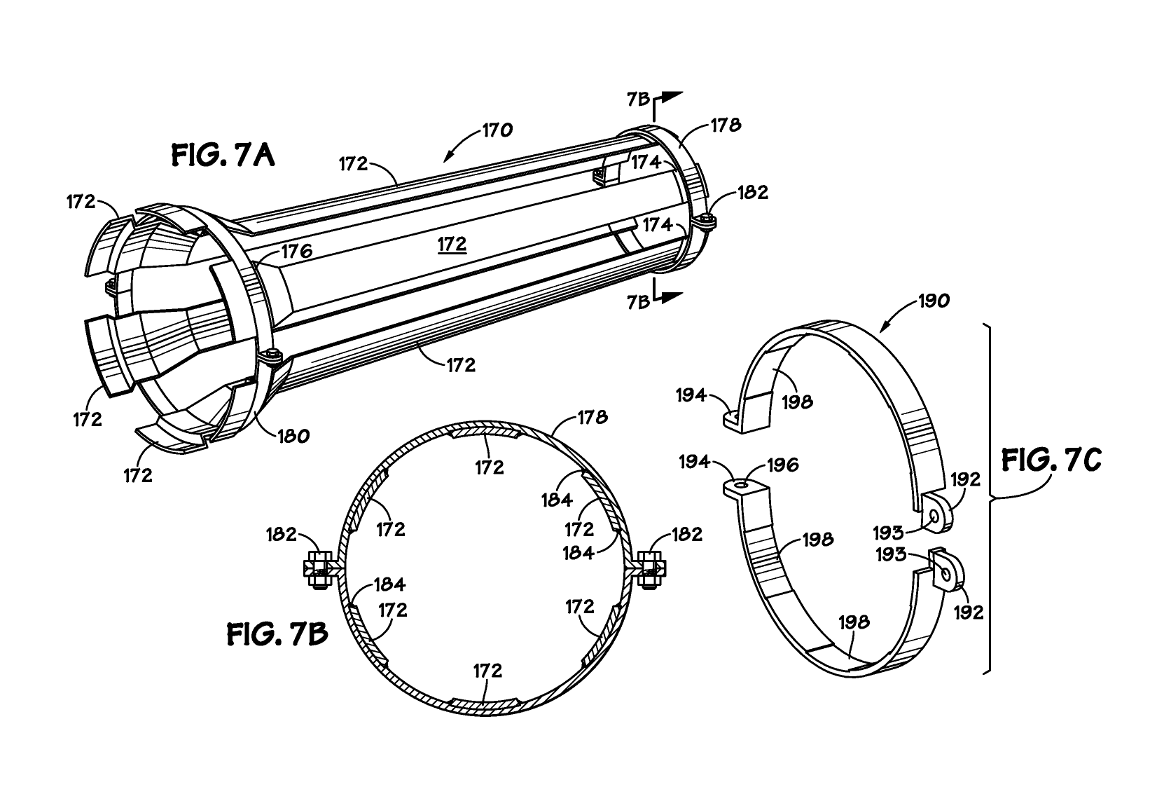

FIG. 7A is an isometric view of a tendon sleeve according to a fifth embodiment of the invention.

FIG. 7B is a cross-sectional view taken along the line indicated in FIG. 7A.

FIG. 7C is an isometric view of an alternative clamp for use in connection with the embodiment shown in FIG. 7A.

FIG. 8 is a partial side view of a sixth embodiment of the invention shown installed on a bottom tendon connector of different design.

### DETAILED DESCRIPTION OF THE INVENTION

The invention may best be understood by reference to certain illustrative embodiments. Referring now to FIGS. 1 and 2, tendon assembly vessel 10 may have a barge-type hull and may be secured at a desired location using anchor lines 20. Alternatively, a dynamic positioning system (not shown) may be used for station keeping.

Assembly vessel 10 may have one or more cranes 14 on deck 12 for lifting and transferring tendon segments 18 from supply vessel 16 (shown moored alongside vessel 10) to tendon supports 22 on deck 12. Tendon supports 22 are generally aligned with welding station 26, tensioning device 28 and stinger 24. Stinger 24 may be supported by gantry 25 and may project from the aft end of vessel 10. Gantry 25 may be used to adjust the angle of stinger 24 relative to deck 12 (or the plane of supports 22). As will be appreciated by those skilled in the art, the horizontal plane of supports 22 is above the water line of vessel 10. Accordingly, that portion of tendon assembly 30 which is floating at or near the water surface will be at a different elevation than that portion which is supported on supports 22 on deck 12 of vessel 10. Stinger 24 may be used to minimize the bend radius of tendon 30 as it transitions from assembly vessel 10 into its horizontal floating position in the water.

Also shown in FIGS. 1 and 2 is tug 40 equipped with winch 36 which may be a constant-tension winch. Tensioning line 34 is attached to winch 36 and first end 38 of tendon 30. Tendon tensioning vessel 40 need not be a tugboat, per se, but rather any suitable vessel capable of tensioning tendon 30 via line 34 such that tendon 30 remains substantially aligned with tendon supports 22 on vessel 10 during the assembly of tendon segments 18. Tensioning device 28 transfers the tension load in tendon segment 18′ to vessel 10 and feeds the assembled portion of the tendon into the sea via stinger 24. In certain embodiments, the propulsion system of tensioning vessel 40 and/or winch 36 may form a part of a dynamic positioning system for vessel 10.

As may best be seen in FIG. 1A, one or more floatation jackets 32 may be installed on selected segment(s) 18′ of tendon 30 during tendon assembly to ensure the desired buoyancy while the tendon undergoing assembly is floating in the sea in a generally horizontal orientation.

Tendons may be assembled from tendon segments 18 by any suitable method. Most commonly, tendon segments 18 will be joined together by welding at station 26. Alternatively, mechanical tendon connectors may be installed and clamped to tendon sections at station 26. In certain embodiments, floatation devices 32 may be installed at station 26.

A pipe tensioning device 28 according to the prior art is shown in FIG. 2A. It will be appreciated that tendon segments 18 have the same configuration as thick-walled pipe and may generally be manipulated using equipment designed for pipe handling.

Tensioner 28 comprises base 102 which may be attached to deck 12 of the tendon assembly vessel to thereby transfer the tension load applied to the tendon under assembly to that vessel. Lower drive unit 108 which comprises a drive motor 110 and a drive belt or conveyor track 112 is mounted on base 102. Upper drive unit 106 which also comprises a drive motor 110 and a drive belt or conveyor track 112 is mounted on frame 104. Tensioner frame 104 is hinged to base 102 to permit the pipe tensioning device to be opened in order to load pipe segment 18 therein.

It will be appreciated by those skilled in the art that the juncture between the tendon bottom connector and the tubular segments which comprise the tendon body may constitute a discontinuity that may adversely affect the operation of the pipe tensioning device. A pipe tensioning device of the type shown in FIG. 2A is generally configured for pipe of a certain diameter (or pipes having a diameter which falls within a certain range of diameters). Moreover, currently available pipe tensioning devices are designed to interface with pipe—i.e., generally cylindrical tubular members. Non-cylindrical elements (such as bottom tendon connectors) may obstruct, cause slippage in, or jam a conventional pipe tensioning device. The present invention solves this problem by providing a smooth transition in outer diameter from the tendon body to the bottom tendon connector.

It will also be appreciated by those skilled in the art that the practice of the above-described and illustrated method of assembling a tendon horizontally in the sea requires means for attaching tug 40 to end 38 of tendon 30. It is advantageous to attach line 34 to an element of tendon 30 that is designed to withstand a tensile load. One such element is the bottom tendon connector—more particularly, the locking lugs of the bottom tendon connector which are designed to engage the anchor pile in the seafloor. The present invention provides means for transferring the tension load of line 34 to tension-bearing members of the bottom tendon connector. First end 38 of tendon 30 may be either the end having the bottom tendon connector or the end having the top tendon connector. When the bottom tendon connector is on the end of tendon 30 which is opposite first end 38, it is still advantageous to have tension application means attached to the second end—e.g., a winch on barge 10—so that tendon 30 can be kept substantially linearly aligned while floating in the sea by applying tension to both ends.

Referring now to FIGS. 3 and 5, a first embodiment of the invention is shown installed on the lower portion of a tendon 118 that is equipped with a tendon bottom connector 122 of the type supplied by Oil States Industries, Inc. (Arlington, Tex.) as the ROTOLATCH™ tendon bottom connector. Sleeve 120 may surround a portion of the lowest tendon section, tapered transition piece 126, spool piece 154 (see FIG. 5) and the upper portion of tendon bottom connector 122 so as to provide a smooth, tapered transition among these pieces. Tendon sleeve 120 has smaller diameter end 128 oriented towards the upper end of tendon 118 and opposing larger diameter end 130 which may be configured to fit over a portion of bottom connector 122.

One or more grooves may be provided in the outer surface of sleeve 120 to locate bands or straps 134 and 134′ which may hold the two halves of sleeve 120 together. Connector 135 which may, in some embodiments, be a band strap cinch, secures band 134 around the tendon sleeve. Bands or straps 134 and 134′ may be cut to remove sleeve 120 from tendon 118. In certain applications, banding straps 134 and 134′ may be cut by a subsea Remotely Operated Vehicle (ROV) after the tendon is upended at the TLP installation site.

The particular type of bottom tendon connector illustrated in FIGS. 3, 5 and 6 has radially projecting lugs 124 which are designed to be tension-bearing elements. Bell portion 148 of tendon sleeve 120 may have a shoulder 138 configured to bear against lugs 124 when the sleeve 120 is installed on tendon 118. Towing or tensioning bridle 132 may be attached to sleeve 120 at any convenient location proximate larger diameter end 130. Alternatively, as shown in phantom in FIG. 3, bridle 132 may be looped through water entry holes 150 in bottom tendon connector 122.

It will be appreciated that the installation of sleeve 120 on tendon 118 creates an annular chamber, the major portion of which is defined by the inner surface of sleeve 120 and the outer surface of spool piece 154. This chamber may be advantageously used to add supplemental flotation to the lower end of tendon 118. This may be of particular utility when tendon 118 is floating horizontally in the sea during the assembly operation and prior to being upended during the installation procedure.

The supplemental flotation may take any conventional form—e.g., molded foam pieces, air cans, air bags and the like. In the illustrated embodiment, flotation material 144 is a solid material configured in two halves which fit together around spool piece 154 within the above-described annulus. Flotation piece 144 may have one or more grooves 146 and 146′ in its outer surface to locate banding straps 136 and 136′ which may hold the two halves of flotation piece 144 together. As in the case of bandings straps 134, connector 137 may, in some embodiments, be a band strap cinch which acts to secure band 136. Bands or straps 136 and 136′ may be cut to remove flotation device 144 from tendon 118. In certain applications, banding straps 136 and 136′ may be cut by a subsea Remotely Operated Vehicle (ROV) after the tendon is upended at the TLP installation site and sleeve 120 is removed. In certain embodiments, tendon 118 may be provided with indicator bands 152 and/or 152′ (see FIG. 5) to assist an ROV in positioning itself relative to tendon 118 and tendon sleeve 120.

FIG. 4 is an exploded view of the tendon sleeve 120 and flotation device 144 shown in FIG. 3. Tendon sleeve 120 comprises shell halves 140 and 140′ which, when assembled, abut one another at edges 142 and 142′. In the illustrated embodiment, edges 142 and 142′ comprise a butt joint. In other embodiments, edges 142 and 142′ may be beveled, tongue-and-groove, splined or otherwise configured for joining by methods well-known in the art. If, as illustrated in FIG. 4, flotation material 144 is likewise configured as split halves, the adjoining edges of the mating halves may also be similarly profiled or otherwise equipped for aligned joining by any of the above-mentioned methods.

FIGS. 6A, 6B and 6C show alternative embodiments of the invention, each configured for use on a tendon equipped with the same type of bottom tendon connector as that shown in FIGS. 3 and 5. The embodiment illustrated in FIG. 6A has radial flange 156 configured to bear against the adjacent surface of bottom tendon connector 122. Flange 156 may be a tension-load bearing member and may thus serve to avoid any damage to lugs 124 which might occur during tendon towing or tensioning operations by providing a greater contact area.

The embodiment illustrated in FIG. 6B includes individual lug pockets 158 in end 130 of tendon sleeve 120. Lug pockets 158 both cover lugs 124 (thereby protecting them from mechanical damage) and prevent the rotation of sleeve 120 relative to tendon 118.

FIG. 6C shows an embodiment which has individual lug notches 160 in end 130 of tendon sleeve 120. Lug notches 160 allow the outside diameter of sleeve 120 to be somewhat smaller than that of the embodiments illustrated in FIGS. 3, 5, 6A and 6B and also act to prevent the rotation of sleeve 120 relative to tendon 118.

FIG. 8 illustrates how a tendon sleeve according to the invention may be adapted to fit tendons having other types of bottom tendon connectors.

FIG. 8 shows the lower end of a tendon 218 having a bottom tendon connector 222 of the type described in U.S. Pat. No. 7,621,698 to Pallini et al. and assigned to Vetco Gray, Inc. (Houston, Tex.). Bell portion 248 is configured to fit the upper end (as installed) of tendon connector 222. The illustrated embodiment comprises tension load-bearing radial flange 256 in contact with the cap ring 223 of the tendon connector 222. In this way, the tensioning load from bridle 232 may be transferred to tendon 218 during its assembly and installation operations.

FIGS. 7A and 7B show yet another embodiment of the invention. In this embodiment, open-frame sleeve 170 comprises a plurality of contoured segments 172 which are held in a spaced-apart configuration by clamps 178 and 180. Optional recesses 174 and 176 in segments 172 may be provided for locating clamps 178 and 180, respectively. As may be best seen in the cross-sectional view of FIG. 7B, the inner surface of clamp 178 may have recesses for locating segments 172 which, in certain embodiments, may be welded (at 184) to clamp 178. The two halves of clamp 178 may have flanges which permit the two halves to be bolted together with bolts 182. Sleeve 170 may be removed from a tendon on which it is installed by removing bolts 182—e.g., using an ROV—and allowing the two halves of the open-frame sleeve to fall away. Clamp 180 may be similarly configured.

An alternative hinged clamp 190 is shown in FIG. 7C. Each half of hinged clamp 190 has a hinge plate 192 with a thru-hole 193. A bolt or the like (not shown) may secure the opposing hinge plates 192 together and act as a hinge pin. The opposite side of clamp 190 may have a flange 194 on each half with a thru-hole 196. A bolt (not shown) may be used to secure the opposing flanges 194 together. Optional recesses 198 on the inner surface of clamp 198 may be provided for locating sleeve segments 172.

A tendon sleeve equipped with hinged clamps 190 may be removed from a tendon by removing the bolt (or other such fastener) which secures flanges 194 together and opening the sleeve by pivoting the two halves of clamp 190 on hinge plates 192. This may be accomplished with an ROV after the tendon is upended at the installation site or by divers when the tendon is floating near the surface.

Although the invention has been described in detail with reference to certain preferred embodiments, variations and modifications exist within the scope and spirit of the invention as described and defined in the following claims.

What is claimed is:

1. A sleeve configured for attachment to a subsea tendon that comprises a plurality of tubular segments having a first outside diameter and a bottom tendon connector having a second outside diameter comprising:
a longitudinally segmented tubular member having a first end with an inside diameter approximately equal to the first outside diameter of the tendon and an opposing second end having an inside diameter substantially equal to the second outside diameter of the tendon; and,
means for holding the segments together around at least a portion of the tendon bottom connector and a portion of the tendon segment proximate the bottom connector.

2. A sleeve as recited in claim 1 wherein the means for holding the segments together comprises banding straps.

3. A sleeve as recited in claim 2 wherein the sleeve further comprises at least one groove on the outer surface of the tubular member sized and configured to contain a banding strap.

4. A sleeve as recited in claim 1 wherein the tubular member is longitudinally segmented into halves which are substantially the mirror image of one another.

5. A sleeve as recited in claim 4 wherein the joining edges of each half are beveled.

6. A sleeve as recited in claim 4 wherein the joining edges of each half are splined.

7. A sleeve as recited in claim 4 wherein the joining edges of each half are configured as a tongue-and-groove joint.

8. A sleeve as recited in claim 1 further comprising an inwardly projecting radial flange sized and configured to bear against one end of the tendon bottom connector when the sleeve is attached to the tendon.

9. A sleeve as recited in claim 1 wherein the second end of the sleeve has a stepped outer diameter and a shoulder sized and configured to bear against radially projecting lugs on the bottom connector of the tendon.

10. A sleeve as recited in claim 1 wherein the second end of the sleeve has a plurality of substantially semicircular covered recesses sized and configured to engage radially projecting lugs on the bottom connector of the tendon.

11. A sleeve as recited in claim 1 wherein the second end of the sleeve has a plurality of substantially semicircular cutouts sized and configured to engage radially projecting lugs on the bottom connector of the tendon.

12. A sleeve as recited in claim 1 further comprising a towing bridle attached at or near the second end of the sleeve.

13. A sleeve as recited in claim 1 further comprising a flotation device sized and configured to fit within an annular space between the inner surface of the sleeve and the outer surface of the tendon.

14. A sleeve as recited in claim 13 wherein the flotation device is selected from the group consisting of molded foam pieces, air cans and air bags.

15. A sleeve as recited in claim 14 wherein the flotation device is longitudinally segmented in the same manner as the sleeve.

16. An open-frame sleeve configured for attachment to a subsea tendon that comprises a plurality of tubular segments having a first outside diameter and a bottom tendon connector having a second outside diameter comprising:
a tubular member comprised of a plurality of longitudinal, spaced-apart segments and having a first end with an inside diameter approximately equal to the first outside diameter of the tendon and an opposing second end having an inside diameter substantially equal to the second outside diameter of the tendon; and,
at least one radially segmented circumferential band attached to the segments such that the segments are held in a circumferentially spaced-apart array around at least a portion of the tendon bottom connector and a portion of the tendon segment proximate the bottom connector.

17. A sleeve as recited in claim 16 wherein the segments of the circumferential band are bolted together.

18. A sleeve as recited in claim 16 wherein the segments of the circumferential band are hinged together.

19. A sleeve as recited in claim 16 wherein the inner surface of the circumferential band comprises recesses sized and spaced to accommodate the longitudinal segments of the open-frame sleeve.

20. A method for assembling a tendon for a tension leg platform comprising:
installing a tendon sleeve according to claim 1 on a partially assembled tendon;
joining tendon segments together in a horizontal orientation on a first floating vessel to produce a tendon assembly; and,
simultaneously applying a tension load to the tendon assembly with a second vessel connected via a towing line to the tendon sleeve installed on a first end of the tendon assembly that is remote from the first vessel.
